(19) United States
(12) Patent Application Publication
(10) Pub. No.: US 2024/0042258 A1
(43) Pub. Date: Feb. 8, 2024

(54) NONFLUORINATED AGENT FOR LIQUID VEHICLE SYSTEMS

(71) Applicant: Tyco Fire Products LP, Cranston, RI (US)

(72) Inventor: Katherine L. Zabronsky, Marinette, WI (US)

(73) Assignee: Tyco Fire Products LP, Cranston, RI (US)

(21) Appl. No.: 18/490,101

(22) Filed: Oct. 19, 2023

Related U.S. Application Data
(63) Continuation of application No. PCT/IB2022/059964, filed on Oct. 18, 2022.
(60) Provisional application No. 63/270,219, filed on Oct. 21, 2021.

(51) Int. Cl. A62D 1/00

(52) U.S. Cl. CPC A62D 1/0042

(57) ABSTRACT

Firefighting compositions that may be used in onboard firefighting systems of heavy industrial equipment, such as heavy vehicles and other types of heavy equipment used in construction, forestry, mining, and other similar industries, are provided. The firefighting composition are aqueous liquids, which include (a) a potassium salt of an organic acid; (b) an alkylpolyglycoside surfactant; (c) a zwitterionic surfactant; and (d) alkylene gly col solvent and/or glycerol. Methods of using the aqueous firefighting composition to fight a fire. such as fighting a fire using an onboard industrial equipment firefighting system, are also provided.

### CROSS-REFERENCE TO RELATED APPLICATIONS

This application is claims the benefit of priority to U.S. Provisional Patent Application No. 63/270,219, filed on Oct. 21, 2021, the contents of which are incorporated herein by reference in their entirety.

### BACKGROUND

Valuable heavy industrial equipment, such as off-road vehicles and other types of heavy equipment used in construction, forestry, mining, and other industries, is used throughout the world, often in remote and/or difficult to access areas. Such off-road industrial vehicles commonly include onboard firefighting systems to protect the vehicle and the operator. The onboard firefighting systems contain a firefighting agent, such as a dry or a wet chemical agent. A common wet chemical agent includes an aqueous film-forming foam (AFFF) type composition that can either be aerosolized to produce a firefighting foam or simply applied as a wet chemical agent to fight fires. The valuable heavy industrial equipment is often used in environments having high or low temperatures and other harsh environmental conditions. Accordingly, firefighting agents used such the onboard firefighting systems are desirably stable under the high and/or low temperatures and harsh environmental conditions in which the valuable heavy industrial equipment is typically used. For example, in regions in which the high value industrial equipment is below a freezing point of water, it is important to deploy firefighting compositions that remain as a stable liquid for prolonged time periods under low temperature conditions.

The onboard firefighting systems of valuable heavy industrial equipment are often designed to fight both Class A and Class B fires. Class A fires are those involving combustible material such as paper, wood, etc. and can be fought by quenching and cooling with large quantities of water or solutions containing water. Class B fires are those involving flammable liquid fuels, gasoline, and other hydrocarbons and are difficult to extinguish. Most flammable liquids exhibit high vapor pressure along with low fire and flash points. This typically results in a wide flammability range. In this type of fire, the use of water as the sole firefighting agent is generally ineffective because the only means of fighting fire with water is through cooling.

Conventional firefighting compositions have commonly included fluorinated and/or perfluorinated surfactants. Environmental concerns related to fluorinated and perfluorinated surfactants have continued to develop. As a result, there is a strong desire in the marketplace to replace fluorinated and perfluorinated surfactant-based firefighting products with fluorine-free products. There is a continuing need to produce fluorine-free firefighting compositions that can be deployed in onboard firefighting systems of heavy industrial equipment while exhibiting fire control performance properties comparable to the existing perfluorinated surfactant-based firefighting products.

Previous attempts to develop fluorine-free firefighting compositions that are stable and maintain satisfactory performance under very low temperature conditions have demonstrated how challenging such requirements are. There is an ongoing need to develop such products, which do not require overly complex mixtures of components and/or less common, expensive components (e.g., specialized surfactants) to provide the required low temperature stability and fire-fighting performance properties.

### SUMMARY

The present application relates generally to firefighting compositions that may be used in onboard firefighting systems of heavy industrial equipment, such as heavy vehicles and other types of heavy equipment used in construction, forestry, mining, and other similar industries throughout the world. The firefighting compositions of the present disclosure are aqueous liquid firefighting compositions that are commonly provided as use-strength compositions. As used herein, the phrase “use-strength composition” means a composition that does not need to be diluted before being deployed to fight a fire. The firefighting compositions described herein are aqueous firefighting compositions that can be aerosolized or often simply sprayed as a wet chemical agent by one or more components of the onboard firefighting system (e.g., a nozzle) to provide a liquid chemical firefighting agent to fight fires and/or suppress flammable vapors. Quite commonly, the nozzles which are employed don't necessarily aerate the wet chemical agent into a foam, but instead simply to distribute liquid agent as-is onto the fire, e.g., distribute the wet chemical agent in a conical spray pattern. Since the valuable heavy industrial vehicles may be used in environments having high or low temperatures and/or other harsh environmental conditions, the firefighting composition used in the onboard firefighting system may be designed to be storage stable under the extreme, harsh conditions in which such heavy industrial equipment may be used. For example, in regions in which the valuable heavy industrial equipment is below a freezing point of water, it is important to deploy firefighting compositions that remain liquid for prolonged time periods under low temperature conditions below the freezing point of water. In some embodiments, such firefighting compositions must remain flowable at temperatures lower than −30° C., lower than −40° C., or even lower than −45° C. As used herein, “flowable” means that a viscosity of the firefighting composition is low enough that the firefighting composition can flow from a storage tank to a dispensing mechanism (e.g., a nozzle, etc.) of the onboard vehicle firefighting system, e.g., typically having a viscosity of no more than about 100 cP at the use temperature and often a viscosity of no more than about 50 cP and, in some instances, no more than about 20 cP.

One exemplary embodiment relates to an aqueous firefighting composition, which includes about 35 to 45 wt. % of a potassium salt of an organic acid having no more than 6 carbon atoms; alkylpolyglycoside as the sole nonionic surfactant; zwitterionic surfactant; about 2 to 15 wt. % water-miscible organic solvent comprising one or more of alkylene glycol and glycerol; and at least about 40 wt. % water. Quite often such compositions are is substantially free of any anionic surfactant and fluorinated additives, e.g., contain no more than about 0.1 wt. % anionic surfactant and/or fluorinated additives. In many instances, the water-miscible organic solvent does not contain any glycol ether solvent. In some instances, the firefighting composition may also include one or more of a chelator, a buffer, a corrosion inhibitor and a preservative.

Another exemplary embodiment relates to an aqueous firefighting composition, which includes about 35 to 45 wt. % potassium acetate and/or potassium formate; alkylpolyglycoside as the sole nonionic surfactant; alkylamidoalkylene zwitterionic surfactant; about 4 to 12 wt. % of a mixture of glycerol with ethylene glycol and/or propylene glycol; and at least about 45 wt. % water. Quite often such compositions are is substantially free of any anionic surfactant and fluorinated additives, e.g., contain no more than about 0.1 wt. % anionic surfactant and/or fluorinated additives.

Another exemplary embodiment relates to an aqueous firefighting composition, which includes at least about 35 wt. % potassium formate;
alkylpolyglycoside as the sole nonionic surfactant; zwitterionic surfactant; water-miscible organic solvent, such as an alkylene glycol and/or glycerol; and at least about 40 wt. % water. Quite often such compositions are is substantially free of any anionic surfactant and fluorinated additives, e.g., contain no more than about 0.1 wt. % anionic surfactant and/or fluorinated additives.

Another exemplary embodiment relates to an aqueous firefighting composition, which includes about 35-45 wt. % potassium formate; one or more C₈₋₁₂ -alkylpolyglycosides as the sole nonionic surfactant; cocamidopropyl hydroxysultaine surfactant; about 3 to 15 wt. % of a mixture of glycerol and propylene glycol; and at least about 45 wt. % water. Quite often such compositions are is substantially free of any anionic surfactant and fluorinated additives, e.g., contain no more than about 0.1 wt. % anionic surfactant and/or fluorinated additives.

Another exemplary embodiment relates to an aqueous firefighting composition, which includes about 35 to 45 wt. % potassium formate; about 0.2 to 3 wt. % of one or more C₈₋₁₂-alkylpolyglycosides as the sole nonionic surfactant; about 0.1 to 1 wt. % of one or more C₈₋₁₄-alkylamidopropyl hydroxysultaine surfactants; about 5 to 10 wt. % of a mixture of glycerol and propylene glycol, and at least about 40 wt. % water. In such compositions the weight ratio of glycerol to propylene glycol is commonly about 0.3:1 to 3:1.

Another exemplary embodiment is related to an aqueous firefighting composition that includes about 35 to 45 wt. % potassium formate; C₈₋₁₂ -alkylpolyglycoside(s) as the sole nonionic surfactant; C₈₋₁₄-alkylamidopropyl hydroxysultaine surfactant(s), such as cocamidopropyl hydroxysultaine; a mixture of glycerol and propylene glycol; and at least about 40 wt. % water. Quite often such compositions are is substantially free of any anionic surfactant and fluorinated additives, e.g., contain no more than about 0.1 wt. % anionic surfactant and/or fluorinated additives. In some embodiments, such compositions are free of any fluorinated additives and may desirably be produced such that the firefighting composition has a total concentration of fluorine atoms on a weight percentage basis of no more than about 1 part per million (ppm) F and often has a substantially lower total fluorine concentration.

### DETAILED DESCRIPTION

The present application provides aqueous firefighting compositions for use in onboard firefighting system of heavy industrial equipment, such as heavy vehicles and other types of heavy equipment used in construction, forestry, mining, and other industries, that are used throughout the world. The firefighting compositions of the present disclosure are aqueous liquid firefighting compositions that may be used as use-strength compositions. As used herein, the phrase “use-strength composition” means a composition that does not need to be diluted before being deployed to fight a fire. The firefighting compositions described herein are aqueous firefighting compositions that can be sprayed or aerosolized by one or more components of the onboard firefighting system (e.g., a nozzle). Since the off-road industrial vehicles are often used in harsh environments having high or low temperatures, the firefighting composition used in the onboard firefighting system is stable under the high or low temperatures and harsh conditions in which the off-road industrial vehicles can be used. For example, in regions in which the high value off-road mining equipment is in high temperature environments, the firefighting composition is stable for temperatures up to 60° C. In another example, in regions in which the high value off-road mining equipment is in low temperature environments below the freezing point of water, it is important to deploy firefighting compositions that remain liquid for prolonged time periods under low temperature conditions. In some embodiments, such firefighting compositions are flowable at temperatures below −30° C. or even below −40° C. As used herein, “flowable” means that a viscosity of the firefighting composition is low enough that the firefighting composition can flow from a storage tank to a dispensing mechanism (e.g., a nozzle, etc.) of the onboard vehicle firefighting system, e.g., typically having a viscosity that is no more than about 100 cP at the low use temperature.

The aqueous firefighting compositions of the present disclosure are commonly substantially free of any fluorinated additives. As used herein, the “phrase substantially free of fluorinated additives” means that the aqueous firefighting composition includes no more than 0.1 wt. % fluorinated additives. In some embodiments, the aqueous firefighting composition includes no more than 0.01 wt. % fluorinated additives. The aqueous firefighting compositions of the present disclosure may be substantially free of fluorine. As used herein, the phrase “substantially free of fluorine” means that the composition has a total concentration of fluorine atoms on a weight percentage basis of no more than about 1 part per million (ppm) F.

In one aspect, the aqueous firefighting compositions of the present disclosure include a) a potassium salt of an organic acid, b) one or more of an alkylpolyglycoside surfactant, and an alkylamidoalkylene zwitterionic surfactant, c) alkylene glycol solvent and/or glycerol, and d) water. The alkylpolyglycoside surfactant is typically the sole nonionic surfactant present in the aqueous firefighting composition. Quite commonly, the aqueous firefighting composition is substantially free of anionic surfactants, e.g., contain no more than 0.1 wt. % and preferably no more than 0.01 wt. % anionic surfactant(s). In some instances, the firefighting composition may also include one or more of a chelator, a buffer, a corrosion inhibitor and a preservative.

The aqueous firefighting compositions commonly include about 35 to 45 wt. % of the potassium salt of one or more organic acids, commonly an organic acid having no more than 6 carbon atoms. The potassium salt of the organic acid(s) may suitably include potassium acetate, potassium formate, potassium propionate, potassium butyrate, potassium lactate, potassium citrate, potassium tartrate, potassium bitartrate, or a mixture of two or more thereof. In some embodiments, the potassium salt of the organic acid may include potassium acetate, potassium formate, potassium lactate, or a mixture of two or more thereof. In some embodiments, the potassium salt of the organic acid includes potassium acetate. In some embodiments, the potassium salt of the organic acid includes potassium lactate. In some embodiments, the aqueous firefighting composition includes about 37 to 43 wt. % of the potassium salt of the organic acid. In such embodiments, the potassium salt of the organic acid may typically include potassium acetate, potassium formate, potassium lactate, or a mixture of two or more thereof. In some embodiments, the aqueous firefighting composition may include about 35 to 45 wt. % potassium formate, and commonly about 37 to 43 wt. % potassium formate.

As discussed above, the aqueous firefighting composition includes a mixture of surfactants, such as an alkylpolyglycoside surfactant as the sole nonionic surfactant and zwitterionic surfactant. Suitable zwitterionic surfactants include alkylamidoalkyl hydroxysultaines, such as one or more C₁₋₁₈-alkylamidopropyl hydroxysultaines, e.g., cocamidopropyl hydroxysultaine. Such aqueous firefighting compositions are generally substantially free of and, in most instances do not contain any anionic surfactant(s). In some embodiments, the aqueous firefighting composition includes about 0.5 to 3 wt. % of such a surfactant mixture. The surfactant mixture may suitably include (a) an alkylpolyglycoside surfactant and (b) one or more C₁₀₋₁₄-alkyliminodipropionate salts and/or C₈₋₁₄-alkylamidopropyl hydroxysultaine surfactants. In other embodiments, the surfactant mixture may suitably include an alkylpolyglycoside surfactant together with one or more C₈₋₁₄-alkylamidopropyl betaine surfactants.

In some embodiments, the aqueous firefighting composition may include a surfactant mixture containing an alkylpolyglycoside surfactant and a zwitterionic surfactant. The surfactant mixture may include one or more surfactants selected from C₈₋₁₂-alkylpolyglycosides and C₁₀₋₁₄-alkyl zwitterionic surfactants. In some embodiments, the aqueous firefighting composition typically includes about 0.5 to 5 wt. % of such a surfactant mixture.

The alkylpolyglycoside surfactant typically includes a C₈₋₁₂ -alkylpolyglycoside, e.g., an alkylpolyglucoside. Suitable examples of the alkylpolyglycoside include a C₈₋₁₂-alkylpolyglycoside having an average degree of polymerization of about 1.3-2.0. Other suitable examples of the alkylpolyglycoside include a C₉₋₁₁-alkylpolyglycoside, such as a C₈₋₁₂-alkylpolyglucoside having an average degree of polymerization of about 1.4-1.7. Commonly, the C₉₋₁₁-alkylpolyglucoside includes a nonyl, decyl, and/or an undecyl polyglucoside. In embodiments that include the alkylpolyglycoside surfactant, the aqueous firefighting composition typically includes about 0.1 to 3 wt. % of the alkylpolyglycoside surfactant, commonly about 0.2 to 2 wt. % of the alkylpolyglycoside surfactant, and often about 0.3 to 1.5 wt. % of the alkylpolyglycoside surfactant.

The zwitterionic surfactant typically includes an aliphatic zwitterionic surfactant, such as an aliphatic amidoalkylene hydroxysultaine surfactant, an aliphatic amidoalkylene betaine surfactant and/or an aliphatic betaine surfactant. The aliphatic zwitterionic surfactant may be an alkylamidoalkylene hydroxysultaine surfactant, an alkylamidoalkylene betaine surfactant, an alkyl hydroxysultaine surfactant and/or an alkyl betaine surfactant. For example, the zwitterionic surfactant may include one or more C₈₋₁₈-alkylamidopropyl hydroxysultaine surfactants, C₈₋₁₈-alkylamidoalkyl betaine surfactants and/or C₈₋₁₈-alkyl betaine surfactants.

Suitable examples of the alkylamidoalkylene hydroxysultaine surfactants include C₈₋₁₈-alkylamidopropyl hydroxysultaine surfactants, such as a cocamidopropyl hydroxysultaine surfactant, which includes a laurylamidopropyl hydroxysultaine and a myristylamidopropyl hydroxysultaine. Suitable examples of the alkylamidoalkylene betaine surfactant include a C₁₋₁₈-alkylamidoalkyl betaine surfactant, such as a cocamidopropyl betaine, a tallowamidopropyl betaine, a laurylamidopropyl betaine or a myristylamidopropyl betaine. In some embodiments, the alkylamidoalkylene zwitterionic surfactant typically may include an alkylamidoalkyl hydroxysultaine surfactant, such as a C₁₋₁₈-alkylamidopropyl hydroxysultaine surfactant, e.g., a cocamidopropyl hydroxysultaine surfactant. In embodiments that include the alkylamidoalkylene zwitterionic surfactant, the aqueous firefighting composition may include about 0.1 to 5 wt. % of the alkylamidoalkylene zwitterionic surfactant, commonly about 0.1 to 3 wt. % of an alkylamidoalkylene zwitterionic surfactant. In embodiments that include the alkylamidoalkylene zwitterionic surfactant, the aqueous firefighting composition may include about 0.1 to 2 wt. % of an alkylamidoalkyl hydroxysultaine surfactant.

The present aqueous fire-fighting compositions typically include a zwitterionic surfactant. The zwitterionic surfactant typically includes one or more of an aliphatic amidoalkyl betaine surfactant, an aliphatic betaine surfactant, an aliphatic sulfobetaine surfactant and an aliphatic amidoalkylene hydroxysultaine surfactant, such as an aliphatic amidopropyl hydroxysultaine surfactant. The zwitterionic surfactant may include one or more of an alkylamidoalkyl betaine surfactant, an alkyl betaine surfactant, an alkyl sulfobetaine surfactant and an alkylamidoalkylene hydroxysultaine surfactant, such as an alkylamidopropyl hydroxysultaine surfactant. For example, the fire-fighting composition may include a zwitterionic surfactant, which comprises one or more of a C₈₋₁₈-alkylamidopropyl hydroxysultaine surfactant, a C₁₋₁₈-alkylamidopropyl betaine surfactant a C₁₋₁₈-alkyl sulfobetaine surfactant and a C₁₋₁₈-alkyl betaine surfactant. Suitable examples of the alkylamidoalkylene hydroxysultaine surfactant include a mixture of two or more C₈₋₁₄-alkylamidoalkyl hydroxysultaine surfactants, such as a cocamidopropyl hydroxysultaine surfactant, which includes a lauryl amidoalkyl hydroxysultaine and a myristyl amidoalkyl hydroxysultaine. Suitable examples of the alkylamidoalkyl betaine surfactant include a C₈₋₁₈-alkylamidoalkyl betaine surfactant, such as a cocamidopropyl betaine, a tallowamidopropyl betaine, a laurylamidopropyl betaine or a myristylamidopropyl betaine. In some embodiments, the zwitterionic surfactant includes one or more C₈₋₁₄-alkylamidopropyl hydroxysultaines, such as a cocamidopropyl hydroxysultaine. In some embodiments, the zwitterionic surfactant includes laurylamidopropyl hydroxysultaine and/or myristylamidopropyl hydroxysultaine. In embodiments that include the zwitterionic surfactant, the aqueous firefighting composition commonly includes about 0.1 to 5 wt. % and often about 0.1 to 3 wt. % of the zwitterionic surfactant. In certain embodiments, the aqueous firefighting composition may include about 0.1 to 2 wt. % and, more commonly, about 0.2 to 1 wt. % of the zwitterionic surfactant.

In some embodiments, the zwitterionic surfactant may include an alkyliminodialkylcarboxylate surfactant, such as a C₁₀₋₁₄-alkyliminodipropionate salt. Suitable examples of the C₁₀₋₁₄-alkyliminodipropionate salt include lauryliminodipropionate salts, myristyliminodipropionate salts, capryliminodipropionate salts or a combination of any two or more thereof. In some embodiments, the alkyliminodialkylcarboxylate surfactant may include a lauryliminodipropionate sodium salt.

As discussed above, the aqueous firefighting composition includes alkylene glycol and/or glycerol. The alkylene glycol typically includes propylene glycol and/or ethylene glycol. In some embodiments, the present fire-fighting composition includes a mixture of alkylene glycol and glycerol. Such mixtures of alkylene glycol and glycerol typically include the alkylene glycol and glycerol in a weight ratio of about 0.1:1 to 5:1. In some embodiments, the mixture of alkylene glycol and glycerol is a mixture of ethylene glycol and glycerol. In some embodiments, the mixture of alkylene glycol and glycerol is a mixture of propylene glycol and glycerol. In many instances, the water-miscible organic solvent does not contain any glycol ether solvent. The aqueous firefighting composition typically includes a total of about 2 to 15 wt. % and in some instances, about 2 to 12 wt. % alkylene glycol and/or glycerol, about 3 to 10 wt. % alkylene glycol and/or glycerol, or about 5 to 10 wt. % alkylene glycol and glycerol.

As discussed above, the aqueous firefighting composition includes water. In some embodiments, the water is water from a municipal water source (e.g., tap water). In some embodiments, the water is a purified water, such as purified water that meets the standards set forth in the United States Pharmacopeia, which is incorporated by reference herein, in relevant part. In some embodiments, the aqueous firefighting composition includes at least about 30 wt. % water. In some embodiments, the aqueous firefighting composition includes at least about 40 wt. % water. In some embodiments, the aqueous firefighting composition includes at least about 45 wt. % water. In some embodiments, the aqueous firefighting composition includes about 45-55 wt. % water. In some embodiments, the aqueous firefighting composition may be produced using a source of water that has a total concentration of fluorine atoms on a weight percentage basis of no more than about 1 ppm F.

Tables 1 and 2 below provides illustrations of suitable formulations of the present firefighting compositions designed for use as fire-fighting agents in systems installed on large high value vehicles, such as large off road mining equipment.

TABLE 1

| COMPONENT | Formula A | Formula B |
|---|---|---|
| Water | ≥40 wt. % | 45-55 wt. % |
| Corrosion Inhibitor | 0-0.1 wt. % | 0-0.1 wt. % |
| Antimicrobial/preservative | 0-0.1 wt. % | 0-0.1 wt. % |
| Alkylene glycol | 1-10 wt. % | 2-8 wt. % |
| Glycerol | 1-6 wt. % | 1-5 wt. % |
| Total polyol solvent | 4-12 wt. % | 5-10 wt. % |
| Alkylpolyglycoside | 0.1-3 wt. % | 0.2-2 wt. % |
| Zwitterionic surfactant | 0.1-2 wt. % | 0.2-1 wt. % |
| Potassium Formate | 35-45 wt. % | 37-43 wt. % |

TABLE 2

| COMPONENT | Formula C | Formula D |
|---|---|---|
| Water | ≥40 wt. % | 45-55 wt. % |
| Tolyltriazole | 0-0.1 wt. % | 0-0.1 wt. % |
| Antimicrobial/preservative | 0-0.1 wt. % | 0-0.1 wt. % |
| Propylene glycol | 1-10 wt. % | 2-8 wt. % |
| Glycerol | 1-6 wt. % | 1-5 wt. % |
| Total polyol solvent | 4-12 wt. % | 5-10 wt. % |
| C₈₋₁₂-Alkylpolyglycoside | 0.1-3 wt. % | 0.2-2 wt. % |
| Cocamidopropyl Hydroxysultaine | 0.1-2 wt. % | 0.2-1 wt. % |
| Potassium Formate | 35-45 wt. % | 37-43 wt. % |

The aqueous firefighting compositions of the present disclosure may be substantially free of any fluorinated additives. As used herein, the “phrase substantially free of fluorinated additives” means that the aqueous firefighting composition includes no more than 0.01 wt. % of fluorinated additives. In some embodiments, the aqueous firefighting composition includes no more than 0.005 wt. % of fluorinated additives. The aqueous firefighting compositions of the present disclosure may be substantially free of fluorine in any form. As used herein, the phrase “substantially free of fluorine” means that the aqueous firefighting composition has a total concentration of fluorine atoms on a weight percentage basis of no more than about 1 ppm F.

In some embodiments, the aqueous firefighting composition can include additional components. For example, the aqueous firefighting composition may also include one or more corrosion inhibitors. An exemplary corrosion inhibitor includes a triazole corrosion inhibitor, such as tolyltriazole. In embodiments that include tolyltriazole, the aqueous firefighting composition may include about 0.005-0.1 wt. % tolyltriazole. In some instances, the aqueous firefighting composition may include magnesium sulfate. In embodiments that include magnesium sulfate, the aqueous firefighting composition suitably includes about 0.1-1 wt. % magnesium sulfate.

### EXAMPLES

The following examples more specifically illustrate formulations for preparing aqueous firefighting compositions according to various embodiments described above. These examples should in no way be construed as limiting the scope of the present technology.

Table 3 below show the composition of a number of exemplary formulations of the present aqueous firefighting composition. The amounts shown in Table 3 represent the weight percentage of the particular component, in its active form, based on the total weight of the composition. The formulations include a potassium salt of an organic acid; an alkylpolyglycoside surfactant; an alkylamidoalkylene zwitterionic surfactant; alkylene glycol and/or glycerol; and water.

TABLE 3

| COMPONENT | Ex. 1 | Ex. 2 | Ex. 3 |
|---|---|---|---|
| Tolyltriazole | 0.04 | 0.04 | 0.04 |
| Propylene glycol | 4 | 6 | 5 |
| Glycerine | 4 | 2 | 3 |
| C₉₋₁₁-Alkylpolyglycoside | 0.75 | 0.75 | 0.75 |
| Cocamidopropyl | 0.5 | 0.5 | 0.5 |
| Hydroxysultaine | | | |
| Potassium Formate | 40.5 | 38.2 | ~39 |
| Water | ~50.2 | ~52.5 | ~51 |

The exemplary aqueous firefighting composition formulations shown in Tables 1-3 can be used as aqueous firefighting compositions in onboard firefighting systems of valuable heavy industrial equipment, such as heavy vehicles and other types of heavy equipment used in construction, forestry, mining, and other industries, as used throughout the world. The exemplary aqueous firefighting compositions shown in Tables 1-3 are provided as use-strength compositions. The formulations shown in Tables 1-3 are typically flowable at temperatures down to at least about −40° C. and, in some instances, may be flowable at temperatures of down to about −45° C. or lower. The fire extinguishing efficacy of the formulations shown in Tables 1-3 can be tested using the FM Approvals Standard 5970 and Australian Standard 5052, both of which are incorporated by reference herein in relevant part. The stability of the formulations shown in Tables 1-3 can be tested using the FM Approvals Standard 5970. For example, the aqueous firefighting compositions disclosed herein commonly remain as homogenous solutions when stored at temperatures of about −40° C. through about 60° C. More specifically, during testing, a first sample of 0.6 L of the aqueous firefighting composition is disposed in a first transparent closed container and stored at about 60° C. undisturbed for 90 days. A second sample of substantially 0.6 L of the aqueous firefighting composition is disposed in a second transparent closed container and stored at about −40° C. undisturbed for 90 days. The first sample and the second sample are examined for stratification at 30, 60, and 90 days. To pass the stability test, no separation or stratification is visible at 30, 60, and 90 days. Visible evidence of stratification includes the development of two or more distinct layers and/or the precipitation of any solids. Cloudiness or other changes in appearance without loss of homogeneity (e.g., without stratification and/or precipitation of solids) is acceptable if the samples produce the same results as unchanged samples when examined by FTIR and when the viscosity is measured.

The exemplary aqueous firefighting formulations shown in Tables 1-3 typically have a pH of about 6 to 10. The exemplary aqueous firefighting formulations shown in Tables 1-3 typically have a pH of about 7 to 9. Commonly, the formulations shown in Tables 1-3 have a pH of about 7.5 to 8.5. If necessary, a pH adjusting agent may be added to a composition to achieve the desired pH range.

The exemplary aqueous firefighting composition formulations described herein typically have a freezing point of no more than about −30° C. Commonly, formulations such as those shown in Tables 1-3 have a freezing point of no more than about −35° C., a freezing point of no more than about −40° C. and, in some instances, have and, in some instances, have a freezing point of no more than about −45° C.

The exemplary aqueous firefighting compositions formulations described herein typically have a Brookfield viscosity of no more than about 100 cP (measured at 60 rpm and at 2° C. using spindle #2). In some embodiments, such formulations may have a Brookfield viscosity of no more than about 50 cP and, in some embodiments, no more than about 20 cP (measured at 60 rpm and at 2° C. using spindle #2).

### Method of Fighting a Fire

As described above, the exemplary aqueous firefighting composition formulations shown in Tables 1-3 can be used as aqueous firefighting compositions in onboard firefighting system of heavy industrial equipment, such as heavy vehicles and other types of heavy equipment used in construction, forestry, mining, and other industries, as used throughout the world. The exemplary aqueous firefighting compositions shown in Tables 1-3 are typically provided as use-strength compositions and can be deployed by an onboard firefighting system of the valuable heavy industrial equipment to protect the valuable heavy industrial equipment and/or an operator thereof from a fire. In some embodiments, the onboard firefighting system is substantially the same as the onboard firefighting system described below.

Typically, the exemplary aqueous firefighting compositions described herein are applied to the fire by spraying the composition as a wet chemical agent without any further dilution. In some embodiments, the onboard firefighting system of the valuable heavy industrial equipment can include a storage tank, a pump, a dispensing mechanism, and a piping system. The piping system is structured to fluidly couple the storage tank, the pump, and the dispensing mechanism. The storage tank is structured to store the aqueous firefighting composition. In some embodiments, the dispensing mechanism includes one or more nozzles. The one or more nozzles may be structured to aerate the aqueous firefighting composition as the aqueous firefighting composition flows through the one or more nozzles. More commonly, however, the aqueous firefighting composition is simply passed through the one or more nozzles to distribute liquid agent as-is onto the fire, e.g., distribute the wet chemical agent in a conical spray pattern.

In response to determining a need to fight a fire (e.g., based on a command input by an operator, information indicative of a fire sensed by one or more sensors in wired or wireless communication with a control system of the onboard firefighting system, etc.), the pump may be structured to pump the aqueous firefighting solution through the piping and the dispensing mechanism to distribute the liquid agent as-is onto the fire from the aqueous firefighting composition.

An exemplary method of fighting a fire with any of the aqueous firefighting compositions described herein includes applying the aqueous firefighting composition to the fire. The method of fighting the fire includes flowing the aqueous firefighting composition from the storage tank of the onboard industrial equipment firefighting system to the dispensing mechanism of the onboard industrial equipment firefighting system. In some embodiments, the dispensing mechanism is one or more nozzles. In some embodiments, the method includes applying the aqueous firefighting composition at a temperature below about −10° C. to the fire. In some embodiments, the method includes applying the aqueous firefighting composition at a temperature below about −20° C. to the fire. In some embodiments, the method includes applying the aqueous firefighting composition at a temperature at or below about −30° C. to the fire. In some embodiments, the method includes applying the aqueous firefighting composition at a temperature at or below about −40° C. to the fire. In some embodiments, the method includes applying the aqueous firefighting composition at a temperature at or below about −45° C. to the fire.

### Illustrative Embodiments

Reference is made to a number of illustrative embodiments of the subject matter described herein. The following embodiments describe illustrative embodiments that may include various features, characteristics, and advantages of the subject matter as presently described. Accordingly, the following embodiments should not be considered as being comprehensive of all of the possible embodiments or otherwise limit the scope of the methods, materials, and compositions described herein.

One exemplary embodiment relates to an aqueous firefighting composition that includes at least about 35 wt. % of an organic acid potassium salt, such as potassium formate; alkylpolyglycoside as the sole nonionic surfactant; zwitterionic surfactant; water-miscible organic solvent, such as an alkylene glycol and/or glycerol; and at least about 40 wt. % water. In some embodiments, such a composition may be substantially free of any fluorinated additives. Quite often such compositions are is substantially free of any anionic surfactant and fluorinated additives, e.g., contain no more than about 0.1 wt. % anionic surfactant and/or fluorinated additives. In some instances, the firefighting composition may also include one or more of a chelator, a buffer, a corrosion inhibitor and a preservative.

In some embodiments of the exemplary aqueous firefighting composition described above, the potassium salt of the organic acid may include one or more of potassium acetate, potassium formate, potassium propionate, potassium butyrate, potassium lactate, potassium citrate, potassium tartrate, potassium bitartrate. In some embodiments, the potassium salt of the organic acid includes potassium acetate, potassium formate, potassium lactate or a mixture of two or more thereof. Preferably, the potassium salt of the organic acid includes potassium formate. In some embodiments, it is advantageous for the potassium salt of the organic acid to consist solely of potassium formate.

In some embodiments of the exemplary aqueous firefighting composition described above, the alkylpolyglycoside may include one or more C₈₋₁₄-alkylpolyglycosides as the sole nonionic surfactant. For example, the alkylpolyglycoside may include one or more C₈₋₁₂-alkylpolyglucosides, e.g., a C₉₋₁₁-alkylpolyglucoside having an average degree of polymerization of about 1.4-1.7. The alkylpolyglycoside may include a C₉₋₁₁-alkylpolyglucoside, which includes a nonyl, decyl and/or an undecyl polyglucoside. Commonly, the composition includes about 0.1 to 5 wt. % of the alkylpolyglycoside, or more commonly, about 0.1 to 3 wt. %; pref. about 0.2 to 2 wt. %.

In some embodiments of the exemplary aqueous firefighting composition described above, the zwitterionic surfactant may include one or more of an aliphatic amidoalkyl betaine, an aliphatic sulfobetaine, an aliphatic amidoalkyl hydroxysultaine and an aliphatic hydroxysultaine, e.g., one or more of an alkyl amidoalkyl betaine, an alkyl sulfobetaine, an alkyl amidoalkyl hydroxysultaine and an alkyl hydroxysultaine. Often, the zwitterionic surfactant includes an aliphatic amidoalkyl hydroxysultaine, such as an alkyl amidopropyl hydroxysultaine. For example, the zwitterionic surfactant may include one or more C₈-C₁₄-alkyl amidopropyl hydroxysultaines, e.g., cocamidopropyl hydroxysultaine. Typically, the composition includes about 0.1 to 5 wt. % and, more commonly, about 0.1 to 3 wt. % of the zwitterionic surfactant. In some instances, the composition includes about 0.1 to 2 wt. % of an alkyl amidopropyl hydroxysultaine, such as cocamidopropyl hydroxysultaine.

In some embodiments of the aqueous firefighting composition described above, the alkylamidoalkylene zwitterionic surfactant includes an alkylamidoalkylene hydroxysultaine surfactant. In some embodiments, the alkylamidoalkylene hydroxysultaine surfactant includes one or more C₈₋₁₈-alkylamidopropyl hydroxysultaine surfactants or more desirably, one or more C₈₋₁₄-alkylamidopropyl hydroxysultaine surfactants, such as cocamidopropyl hydroxysultaine.

In some embodiments of the aqueous firefighting composition described above, the composition includes a water-miscible organic solvent comprising alkylene glycol and/or glycerol. For example, the water-miscible organic solvent may include a mixture of glycerol and an alkylene glycol, such as comprises propylene glycol and/or ethylene glycol. In some instances, the water-miscible organic solvent does not contain any glycol ether solvent. In many instances, the water-miscible organic solvent may include a mixture of the alkylene glycol and glycerol in a weight ratio of about 0.1:1 to 5:1 and, commonly about 0.3:1 to 3:1. In some embodiments, the water-miscible organic solvent includes two or more of ethylene glycol, propylene glycol and glycerol. In many embodiments, the alkylene glycol advantageously includes propylene glycol, e.g., where the water-miscible organic solvent includes a mixture of propylene glycol and glycerol. In some instances, the water-miscible organic solvent may include a mixture of ethylene glycol and glycerol. The present aqueous firefighting compositions commonly include about 2 to 15 wt. %, about 3 to 12 wt. % and, more commonly, about 5 to 10 wt. % of the water-miscible organic solvent. Quite often, the aqueous firefighting composition includes alkylene glycol and glycerol in a weight ratio of about 0.1:1 to 5:1. In some instances, the alkylene glycol includes propylene glycol and/or ethylene glycol. In some instances, the alkylene glycol includes propylene glycol. In some instances, the composition includes a mixture of propylene glycol and glycerol. In some instances, the alkylene glycol includes ethylene glycol. In some embodiments, the composition includes a mixture of ethylene glycol and glycerol. In some instances, the aqueous firefighting compositions may desirably include about 1 to 7 wt. % glycerine and about 2 to 10 wt. % propylene glycol.

Another exemplary embodiment relates to an aqueous firefighting composition including a) about 37 to 45 wt. % potassium formate; b) about 0.2 to 2 wt. % of one or more C₈₋₁₂-alkylpolyglycosides as the sole nonionic surfactant; c) about 0.1 to 1 wt. % of one or more C₈₋₁₄-alkylamidopropyl hydroxysultaine surfactants; d) about 5 to 10 wt. % of a mixture of glycerol and propylene glycol. Such compositions commonly contain about 45 to 55 wt. % water. In such compositions, the weight ratio of glycerol to propylene glycol may be about 0.5:1 to 2:1. Quite often, such compositions contain no more than 0.1 wt. % anionic or fluorinated surfactant. In some instances, the aqueous firefighting composition consists essentially of the components enumerated in this paragraph.

In another exemplary embodiment, the aqueous firefighting composition consists of a) about 37 to 45 wt. % potassium formate; b) about 0.2 to 2 wt. % of one or more C₈₋₁₂-alkylpolyglycosides as the sole nonionic surfactant; c) about 0.1 to 1 wt. % of one or more C₈₋₁₄alkylamidopropyl hydroxysultaine surfactants; d) about 5 to 10 wt. % of a mixture of glycerol and propylene glycol; and e) about 45 to 55 wt. % water.

In any of the exemplary aqueous firefighting compositions described above, the composition may have a Brookfield viscosity at 2° C. of no more than about 50 cP (measured at 60 rpm using spindle #2). In some of the exemplary aqueous firefighting compositions described above, the composition may have a Brookfield viscosity at 2° C. of no more than about 20 cP (measured at 60 rpm using spindle #2).

A method of producing a firefighting foam includes aerating any of the aqueous firefighting compositions described herein, either as is or after dilution with water.

A method of fighting a fire includes applying any of the aqueous firefighting compositions described herein directly onto the fire.

A method of fighting a fire includes spraying any of the aqueous firefighting compositions described herein onto the fire, e.g., by passaging the liquid agent as-is through a nozzle to distribute the wet chemical agent in a conical spray pattern onto the fire.

In some embodiments, the method of fighting the fire described immediately above includes flowing the aqueous firefighting composition from a storage tank of an onboard industrial equipment firefighting system to a dispensing mechanism. In some embodiments, the dispensing mechanism is a nozzle. In some embodiments, the onboard industrial equipment firefighting system is an onboard industrial vehicle firefighting system.

In some embodiments, either of the methods described above include applying any of the aqueous firefighting compositions described above at a temperature below about −10° C. to the fire.

In some embodiments, either of the methods described above include applying any of the aqueous firefighting compositions described above at a temperature below about −20° C. to the fire.

In some embodiments, the methods described above include applying any of the aqueous firefighting compositions described above at a temperature below about −30° C. or even below about −40° C. to the fire.

In some embodiments, the aqueous firefighting composition contains no more than about 0.1 wt. % of any fluorinated additives.

In some embodiments, the aqueous firefighting composition has a total concentration of fluorine atoms on a weight percentage basis of no more than about 1 ppm F.

In some embodiments, the aqueous firefighting compositions described above have a pH of about 6 to 10, about 7 to 9 or even about 7.5 to 8.5.

In some embodiments, the aqueous firefighting composition has a freezing point of no more than about −30° C.

In some embodiments, the aqueous firefighting composition has a freezing point of no more than about −40° C.

In some embodiments, the aqueous firefighting composition has a freezing point of no more than about −45° C.

In some embodiments, a method of producing a firefighting foam includes aerating the aqueous firefighting composition described herein, either as is or after dilution with water . . . .

In some embodiments, a method of fighting a fire includes applying the aqueous firefighting composition described herein to the fire, e.g., by simply spraying or otherwise distributing the aqueous firefighting composition onto the fire.

In some embodiments, the method of fighting a fire includes flowing the aqueous firefighting composition described herein from a storage tank of an onboard industrial equipment firefighting system to a dispensing mechanism. The dispensing mechanism may commonly include one or more nozzles.

While certain embodiments have been illustrated and described, it should be understood that changes and modifications can be made therein in accordance with ordinary skill in the art without departing from the technology in its broader aspects.

The embodiments illustratively described herein may suitably be practiced in the absence of any element or elements, limitation or limitations, not specifically disclosed herein. Thus, for example, the terms “comprising,” “including,” “containing,” shall be read expansively and without limitation. Additionally, the terms and expressions employed herein have been used as terms of description and not of limitation, and there is no intention in the use of such terms and expression of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “and” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

Additionally, where features or aspects of the disclosure are described in terms of Markush groups, those skilled in the art will realize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof.

1. An aqueous firefighting composition comprising:
about 35 to 45 wt. % of a potassium salt of an organic acid having no more than 6 carbon atoms;
a alkylpolyglycoside as the sole nonionic surfactant;
a zwitterionic surfactant;
about 2 to 15 wt. % water-miscible organic solvent comprising one or more of alkylene glycol and glycerol; and
at least about 30 wt. % water;
wherein the composition is substantially free of any anionic surfactant and fluorinated additives.

2. The aqueous firefighting composition of claim 1, wherein the organic acid potassium salt comprises potassium acetate, potassium formate, potassium propionate, potassium butyrate, potassium lactate, potassium citrate, potassium oxalate, potassium tartrate, potassium bitartrate, or a mixture of any two or more thereof.

3. (canceled)

4. The aqueous firefighting composition of claim 1 comprising the potassium salt is potassium formate.

5. (canceled)

6. The aqueous firefighting composition of claim 1, wherein the alkylpolyglycoside comprises one or more C₈₋₁₂-alkylpolyglucosides.

7-8. (canceled)

9. The aqueous firefighting composition of claim 1 comprising about 0.1 to 5 wt. % of the alkylpolyglycoside.

10. The aqueous firefighting composition of claim 1, wherein the zwitterionic surfactant comprises an aliphatic amidoalkyl betaine, an aliphatic sulfobetaine, an aliphatic amidoalkyl hydroxysultaine, an aliphatic hydroxysultaine, or a mixture of any two or more thereof.

11-13. (canceled)

14. The aqueous firefighting composition of claim 1, wherein the zwitterionic surfactant comprises cocamidopropyl hydroxysultaine.

15. The aqueous firefighting composition of claim 1, comprising about 0.1 to 5 wt. % of the zwitterionic surfactant.

16-18. (canceled)

19. The aqueous firefighting composition of claim 1, wherein the water-miscible organic solvent comprises a mixture of propylene glycol and glycerol.

20-26. (canceled)

27. An aqueous firefighting composition comprising:
about 35 to 45 wt. % potassium formate;
about 0.2 to 3 wt. % of one or more C₈₋₁₂-alkylpolyglycosides as the sole nonionic surfactant;
about 0.1 to 1 wt. % of one or more C₈₋₁₄-alkylamidopropyl hydroxysultaine surfactants;
about 5 to 10 wt. % of a mixture of glycerol and propylene glycol, wherein the weight ratio of glycerol to propylene glycol is about 0.3:1 to 3:1; and
at least about 30 wt. % water;
wherein the aqueous firefighting composition contains no more than 0.1 wt. % anionic or fluorinated surfactant.

28. The aqueous firefighting composition of claim 1 containing no more than 0.1 wt. % fluorinated additives.

29. (canceled)

30. The aqueous firefighting composition of claim 1 exhibiting a freezing point of no more than about −40° C.

31. (canceled)

32. The aqueous firefighting composition of claim 1 a Brookfield viscosity at 2° C. of no more than about 50 cP when measured at 60 rpm using spindle #2.

33. (canceled)

34. The aqueous firefighting composition of claim 1 having a pH of about 6 to 10.

35. (canceled)

36. The aqueous firefighting composition of claim 1 further comprising a chelator, a buffer, a corrosion inhibitor, a preservative, or a mixture of any two or more thereof.

37-45. (canceled)

46. A method of fighting a fire, the method comprising applying an aqueous firefighting composition to the fire, wherein the aqueous firefighting composition comprises:
about 35 to 45 wt. % of a potassium salt of an organic acid having no more than 6 carbon atoms;
an alkylpolyglycoside as the sole nonionic surfactant;
a zwitterionic surfactant;
about 2 to 15 wt. % water-miscible organic solvent comprising one or more of alkylene glycol and glycerol; and
at least about 30 wt. % water;
wherein the composition is substantially free of any anionic surfactant and fluorinated additives.

47. The method of claim 46, wherein the method comprises applying the aqueous firefighting composition at a temperature at or below about −10° C. to the fire.

48. The method of claim 46, wherein the method comprises spraying the aqueous firefighting composition onto the fire.

49. The method of claim 48, wherein the method comprises flowing the aqueous firefighting composition from a storage tank of an onboard industrial equipment firefighting system to a dispensing mechanism.

50. The method of claim 49, wherein the onboard industrial equipment firefighting system is an onboard industrial vehicle firefighting system.
